(19) United States
(12) Patent Application Publication
(10) Pub. No.: US 2024/0273806 A1
(43) Pub. Date: Aug. 15, 2024

(54) SMART BIT ALLOCATION ACROSS CHANNELS OF TEXTURE DATA COMPRESSION

(71) Applicant: Meta Platforms Technologies, LLC, Menlo Park, CA (US)

(72) Inventor: Cheng Chang, Redmond, WA (US)

(21) Appl. No.: 18/168,120

(22) Filed: Feb. 13, 2023

(51) Int. Cl. G06T 15/04; G06T 7/40; G06T 9/00

(52) U.S. Cl. CPC G06T 15/04; G06T 7/40; G06T 9/00; G06T 2207/20081; G06T 2207/20084

(57) ABSTRACT

A computing system may receive training texture components; encode each of the training texture components at multiple training bitrates; render multiple reconstructed images associated with multiple total training bitrates for encoding the training components based on combinations of decoded training texture components at the multiple training bitrates; determine a desired reconstructed image for each of the multiple total training bitrates for encoding the training components; extract a desired training bit allocation across the training texture components associated with the desired reconstructed image for each of the multiple total training bitrates for encoding the training texture components; and train a machine-learning model to learn a bit allocation for encoding each of texture components using the training texture components, the multiple total training bitrates for encoding the training components, and the desired training bit allocation across the training texture components.

### TECHNICAL FIELD

This disclosure generally relates to data compression, and more specifically, to bit allocation across channels of texture data compression.

### BACKGROUND

Artificial reality involves the display of computer-generated graphics to a user in an immersive manner. The goal is to cause the user to experience the computer-generated graphics as though they existed in the world before them. Rendering computer-generated graphics for artificial reality is computationally-intensive, often requiring expensive and specialized hardware. This is due at least in part to the requirement that the graphics displayed to the user must be very high quality. For a user to believe that the graphics represent, or are a part of, the world around them, the graphics must be believably high quality. The screen-door effect, where either the graphics or the display used to project the graphics allows the user to see lines between pixels can ruin any sense of immersion. Furthermore, graphics for artificial reality scenes are often interactive-when a user “moves” in the virtual space, the space moves with or in response to them. Latency between a user's movement, or movement command, and displaying the effects of that movement can cause great discomfort to the user, such as virtual-reality sickness. Because a user's movements are typically unpredictable, pre-rendering most components of an artificial reality scene is impractical.

### SUMMARY OF PARTICULAR EMBODIMENTS

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Textures may generally include two-dimensional (2D) images that map to a three-dimensional (3D) surface, in which the individual pixels of the texture images may be referred to as “texels” (e.g., texture elements). As an example and not by way of limitation, during graphics rendering, the textures of visible objects are sampled to generate a final image for display. Physically based rendering (PBR) is typical in today's artificial reality (e.g., AR, VR, MR) applications. Developers and artists use high-resolution PBR texture (e.g., albedo, normal, metallic, roughness, ambient occlusion) maps to describe a material for rendering images to provide users with more realistic and immersive user experiences. PBR textures information is fed to a graphics processing unit (GPU) renderer, and the GPU renderer conducts sophisticated calculations based on the information to decide how lights interact with the surface of a material. Given multiple channels in a PBR texture set, each channel in the PBR texture set may be compressed at different quality. In an example, a base color image that includes (R)ed, (G)reen, (B)lue channels are fed to a physically based renderer with different compression ratios (e.g., 12:1 and 5:1), respectively. The physically based renderer may render similar quality images regardless of the different compression ratios because the pixel values calculated in the rendered image rely less on the base color if those pixels are part of a metal area. The color for a metal region is a combination of the material color and incoming light color, and the incoming light color dominants than the material color. Therefore, it is desired to determine an optimal way of allocating bits among the channels of an arbitrary PBR texture set to achieve the best-rendered quality for any given PBR renderer at any given target compression bitrate.

The present embodiments are directed to techniques for encoding individual texture components separately and providing a method of allocating available bits across different texture components of each pixel per pixel block for texture data compression using a machine learning model. In some embodiments, a computing system (e.g., a codec system) may receive training texture components of an N-bit training physically-based rendering (PBR) texture set (e.g., 64-bit PBR texture set). As an example and not by way of limitation, the training texture components may comprise one or more of (R)ed, (G)reen, (B)lue color components, a metallic component, a normal component, a roughness component, a displacement component, a specular component, ambient occlusion component, an albedo component, a transparency component, and a fuzz component. The computing system may then encode each training texture component at a plurality of training bitrates. As an example and not by way of limitation, the computing system may encode the metallic component at each bit per pixel from 0 bits/pixel to 24 bits/pixel, and may obtain 25 different compressed metallic components. The computing system may then render a plurality of reconstructed images associated with a plurality of total training bitrates for encoding the training components based on combinations of decoded training texture components at the plurality of training bitrates. As an example and not by way of limitation, the computing system may render the reconstructed images based on all possible combinations of the encoded training texture components. The computing system may continue to determine a desired reconstructed image for each of the plurality of total training bitrates for encoding the training components. As an example and not by way of limitation, the total training bitrates for encoding the training components of a 64-bit PBR texture set may have a range of 8 bits/pixel to 32 bits/pixel indicating a compression ratio is between ⅛ to ½. The computing system may determine the desired reconstructed image at each total training bitrates (e.g., from 8 bits/pixel to 32 bits/pixel). The computing system may then extract a desired training bit allocation across the training texture components associated with the desired reconstructed image for each of the plurality of total training bitrates for encoding the training texture components. As an example and not by way of limitation, the computing system may receive the training PBR texture set with 4 different training texture components, the desired training bit allocation may be [b1, b2, b3, b4] (e.g., b1—corresponding to the all of the first of the training texture components; b2—corresponding to the all of the second of the training texture components; b3—corresponding to the all of the third of the training texture components; and b4—corresponding to the all of the fourth of the training texture components) across the training texture components associated, wherein the summation of b1, b2, b3, and b4 equals to the total training bitrates (e.g., 8 bits/pixel). The computing system may then train a machine-learning model to learn a bit allocation for encoding each of the texture components using the training texture components, the plurality of total training bitrates for encoding the training components, and the desired training bit allocation across the training texture components.

In some embodiments, the computing system may determine image qualities of the plurality of reconstructed images based on comparisons to the image rendered from the training PBR texture set. The training PBR textures set may be the original uncompressed PBR texture set. The computing system may then determine the desired reconstructed image for each of the plurality of total training bitrates for encoding the training components based on the image qualities.

In some embodiments, the computing system may access target texture components of a pixel region in a target PBR texture set. The computer system may receive a target bitrate for encoding the target texture components of the pixel region in the target PBR texture set. The computing system may use the machine learning model to determine a target bit allocation for encoding each of the target texture components of the pixel region based on the target bitrate. The computing system may continue to encode each of the texture components of the pixel region using the target bit allocation.

In some embodiments, the method may determine one or more texture features that describe one or more material properties (e.g., metal material) of the image and/or a pixel block of the image. As an example and not by way of limitation, in some embodiments, the one or more texture features may comprise a mean (e.g., an average of the total pixel value) and a variance (e.g., a measure of the average degree to which each PBR texture component is different from the mean value) of an N-bit PBR image (e.g., on a pixel region by pixel region basis). The computing system may train the machine learning model to learn the bit allocation for encoding each of the texture components based on the one or more texture features of each training texture component, the plurality of total training bitrates for encoding the training components, and the desired training bit allocation across the training texture components.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system.

FIG. 1B illustrates an example augmented reality system.

FIG. 2 illustrates an example encoder-decoder (codec) system.

FIG. 3 illustrates an example renderer-aware smart bit allocation system.

FIG. 4 illustrates a comparison of images rendered by physically based renderer of different base color compression ratios for metal material.

FIG. 5 illustrates an example of a rendering quality evaluation pipeline.

FIG. 6 illustrates an example plot for determining a desired bit allocation for each of the plurality of total training bitrates for encoding the training components of a training texture set.

FIG. 7 illustrates a flow diagram of a method for training a machine-learning model to learn a smart bit allocation across channels for encoding each texture component of a physically based rendering texture set.

FIG. 8 illustrates a flow diagram of a method for determining a smart bit allocation across channels for textures components compression

FIG. 9A illustrates an example of pre-analysis of the texture components by extracting texture features.

FIG. 9B illustrates an example of pre-analysis of the texture components with a conventional neural network.

FIG. 10 illustrates an example artificial neural network.

FIG. 11 illustrates an example computer system.

### DESCRIPTION OF EXAMPLE EMBODIMENTS

Because artificial reality devices involve creating digital scenes or superposing computer-generated imagery onto a view of the real world, they provide a platform for designers and engineers to provide new forms of information, entertainment, or methods of collaboration. As an example and not by way of limitation, artificial reality devices may allow users to communicate, seemingly in person, over long distances, or assist users by informing them of the environment around them in an unobtrusive manner. Because artificial reality experiences can often be customized, the user's experience with artificial reality may be deeply personal and highly engaging if presented with sufficient clarity and convenience.

One way that artificial reality experiences can augment human ability is with computer-generated images and/or text added to the real world, as in an augmented or mixed reality. From this simple principle, a variety of compelling use cases can be considered. Labels (e.g., texts, glyphs, etc.) or images describing a real-world object may be fixed in the world space (e.g., location-aware labels acting as street signs or providing a live map of a bike path), or images fixed to a real-world object as it moves through the space (e.g., a label added to a bus as it going on its route that provides detailed information about its route or capacity). Labels could also be used to help a user navigate through an unfamiliar city (e.g., creating a waypoint for the nearest restroom), or help find a friend in a crowd (e.g., a socially-aware waypoint fixed to another user). Other experiences worth considering may be based on interactions with real-world objects. As an example and not by way of limitation, a user could “project” video onto a wall or screen that allows for the video to be played and visible to only herself or to others with access to a shared augmented space. As another example, a user could fix computer-generated text to a physical object to act as an augmented-reality book or magazine. Content could be displayed relative to the object (allowing a user to physical asset aside an augmented-reality) or could be displayed in a fixed relation to the user's (e.g., a tutorial video constantly playing in a corner of the view). Presented media could be customized to the user, so that the same content display space could content relevant to each person viewing the same physical space. As another example, a user could interact with computer-generated graphics by “touching” an icon, or “manipulating” the computer-generated images manually. These graphics could be shown to multiple users working on a project, enabling opportunities for team collaboration (e.g., multiple architects working on a three-dimensional digital prototype in a building together in real-time).

To facilitate use, the display that outputs the computer-generated graphics should be intuitive, constantly accessible, and unobtrusive. One approach for displaying high definition artificial reality graphics to a user is based on a head-mounted display. The user wears an apparatus, such as a visor, headset, or glasses, capable of displaying computer graphics display. In augmented or mixed reality experiences, the computer graphics can be seen alongside, or on top of, the physical world. However, rendering these computer graphics is computationally intensive. Therefore, in most cases rendering is performed by powerful computers communicatively attached (e.g., via a cable or wireless communication protocol, such as Bluetooth) to a head-mounted display. In such a configuration, the head-mounted display is limited by bulky cords, bandwidth and power limitations, heat restrictions, and other related constraints. Yet, the limits of these constraints are being pushed. Head-mounted displays that are comfortable and efficient enough for day-long wearing, yet powerful enough to display sophisticated graphics are currently being developed.

One technique used to reduce actual display size without impacting apparent display size is known as a scanning display. In a scanning display, multiple smaller images are combined to form a larger composite image. The scanning display uses source light, one or more scanning elements comprising reflectors, and an optics system to generate and output image light. The output image light may be output to the eye of the user. The source light may be provided by emitters, such as light-emitting diodes (LEDs). As an example and not by way of limitation, the light source may be an array of 2560×1440 LEDs. The reflectors may be any suitable reflective surface attached to the scanning element. In particular embodiments, the scanning element may be a scanning mirror driven using one or more microelectromechanical systems (MEMS) components. The optics system may comprise lenses used to focus, redirect, and otherwise augment the light. The scanning element may cause the source light, treated by light guiding components, to be output to the eye of the user in a specific pattern corresponding to a generation pattern used by the emitters to optimize display draw rate. Because, As an example and not by way of limitation, all emitters need not be active at once, and in addition to a variety of other factors, scanning displays may require less power to run, and may generate less heat, than traditional display comprised of the same emitters. They may have less weight as well, owing in part to the quality of the materials used in the scanning element and optics system. One consequence of using a scanning display is that in exchange for, e.g., power, weight, and heat efficiency, a scanning displays may not perfectly display images as presented to them, e.g., images intended for traditional displays. There may be non-uniform distortions such as geometric warping of images and distortion of colors and specifically brightness. As is explained further herein, these distortions can be corrected by post-processing graphics to-be displayed to counteract the distortion before they are passed to the display, creating the effect that there is no distortion. Although this disclosure describes displays in a particular manner, this disclosure contemplates any suitable displays.

Since its existence, artificial reality (e.g., AR, VR, MR) technology has been plagued with the problem of latency in rendering AR/VR/MR objects in response to sudden changes in a user's perspective of an AR/VR/MR scene. To create an immersive environment, users may need to be able to move their heads around when viewing a scene and the environment may need to respond immediately by adjusting the view presented to the user. Each head movement may slightly change the user's perspective of the scene. These head movements may be small but sporadic and difficult, if not impossible, to predict. A problem to be solved is that the head movements may occur quickly, requiring that the view of the scene be modified rapidly to account for changes in perspective that occur with the head movements. If this is not done rapidly enough, the resulting latency may cause a user to experience a sensory dissonance that can lead to virtual reality sickness or discomfort, or at the very least, a disruption to the immersive nature of the experience. Re-rendering a view in its entirety to account for these changes in perspective may be resource intensive, and it may only be possible to do so at a relatively low frame rate (e.g., 60 Hz, or once every 1/60th of a second). As a result, it may not be feasible to modify the scene by re-rendering the entire scene to account for changes in perspective at a pace that is rapid enough (e.g., 200 Hz, once every 1/200th of a second) to prevent the user from perceiving latency and to thereby avoid or sufficiently reduce sensory dissonance. One solution involves generating a two-dimensional (2D) image of an object's texture from a particular view of the object, which maps to a three-dimensional (3D) “surface” of the object within the scene. A surface, or texture image, is comprised of object primitives that represent a particular view of the object. A surface corresponds to one or more objects that are expected to move/translate, skew, scale, distort, or otherwise change in appearance together, as one unit, as a result of a change in perspective. Instead of re-rendering the entire view, a computing system may simply resample these surfaces from the changed perspective to approximate how a corresponding object would look from the changed perspective. This method may significantly reduce the rendering processing and thus ensure that the view is updated quickly enough to sufficiently reduce latency. Resampling surfaces, unlike re-rendering entire views, may be efficient enough that it can be used to modify views within the allotted time—e.g., in 1/200th of a second—with the relatively limited processing power of a computing system of a HMD. It may not be feasible for a system that is physically separate from the HMD (e.g., a separate laptop or wearable device) to perform the resampling process because the time scales involved in the resampling process are extremely small. As an example and not by way of limitation, if the resampling process were to be performed in a physically separate system, the HMD would have to transmit information about the current position and orientation of the HMD, wait for the separate system to render the new view, and then receive the new view from the separate system. The present embodiments, to further improve image quality of the physically based renderer given a target bitrate, provide compression techniques for compressing texture components of a PBR texture set based on a smart bit allocation and providing a method for training a machine-learning model to determine smart bit allocation for different materials across channels of a the PBR texture set to achieve the best rendered image quality.

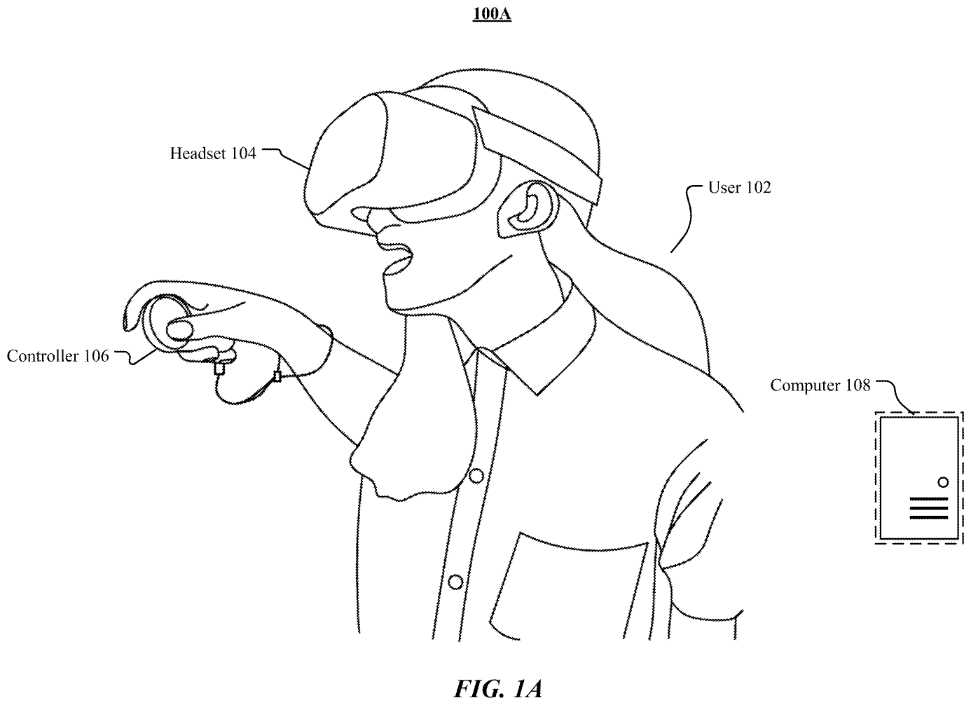

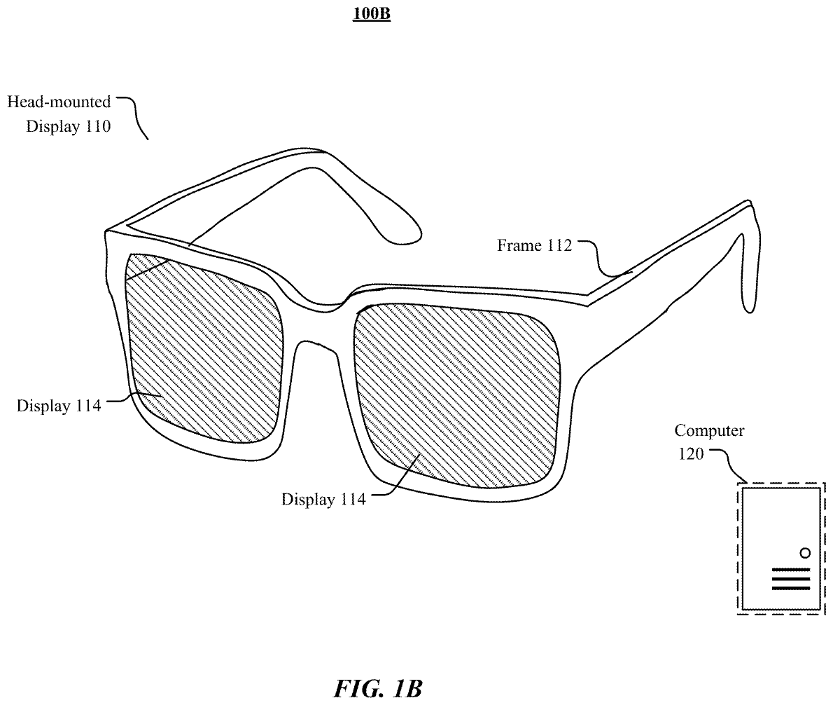

FIG. 1A illustrates an example artificial reality system 100A. In particular embodiments, the artificial reality system 100A may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may be referred as a head-mounted display (HDM). The controller 106 may comprise a trackpad and one or more buttons. The controller 106 may receive inputs from the user 102 and relay the inputs to the computing system 108. The controller 206 may also provide haptic feedback to the user 102. The computing system 108 may be connected to the headset 104 and the controller 106 through cables or wireless connections. The computing system 108 may control the headset 104 and the controller 106 to provide the artificial reality content to and receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

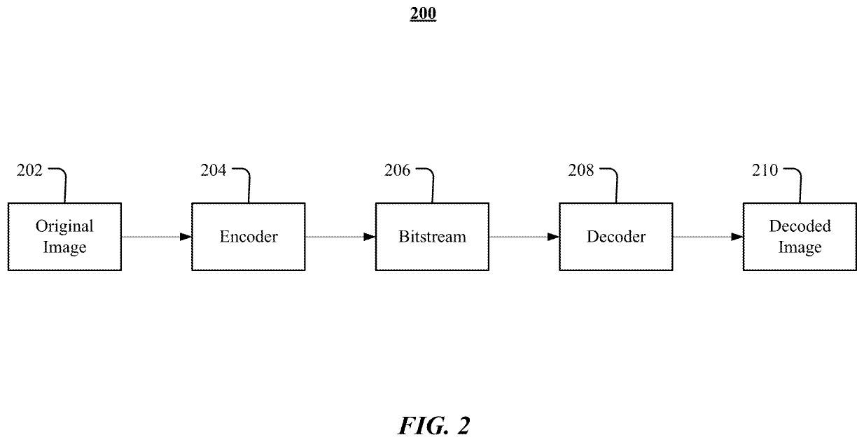

FIG. 2 illustrates an encoder-decoder (codec) system 200 that may be useful in performing forgoing techniques as discussed herein, in accordance with the presently disclosed embodiments. In some embodiments, the codec system 200 may be implemented as part of a subsystem on one or more general purpose processors, or may include a standalone graphic processing units (GPU), an application-specific integrated circuit (ASIC), a system-on-chip (SoC), a microcontroller, a field-programmable gate array (FPGA), or any other processing device(s) that may be suitable for processing image data. As depicted in FIG. 2, in some embodiments, the data flow of the codec system 200 may include receiving an original image 202 to be encoded via an encoder device 204, stored into a bitstream 206, and decoded via a decoder device 208 to generate a compressed and decoded image 210 to be stored and/or transmitted.

In one embodiment, the original image 202 may include one or more 8-bit color images (e.g., still image frames, video image frames) including, As an example and not by way of limitation. In other embodiments, the original image 202 may include a 2-bit color image, a 4-bit color image, a 6-bit color image, a 10-bit color image, a 12-bit color image, a 16-bit color image, a 24-bit color image, or any suitable N-bit color image that may be received and processed by the codec system 200. In certain embodiments, the encoder device 204 may include any device that may be utilized, As an example and not by way of limitation, to receive the original image 202 and convert the original image 202 into a bitstream 206 (e.g., binary pixel data). Similarly, the decoder device 208 may include any device that may be utilized, As an example and not by way of limitation, to receive the encoded bitstream 206 of binary pixel data and decode the bitstream 206 (e.g., binary pixel data) to generate the compressed and decoded image 210.

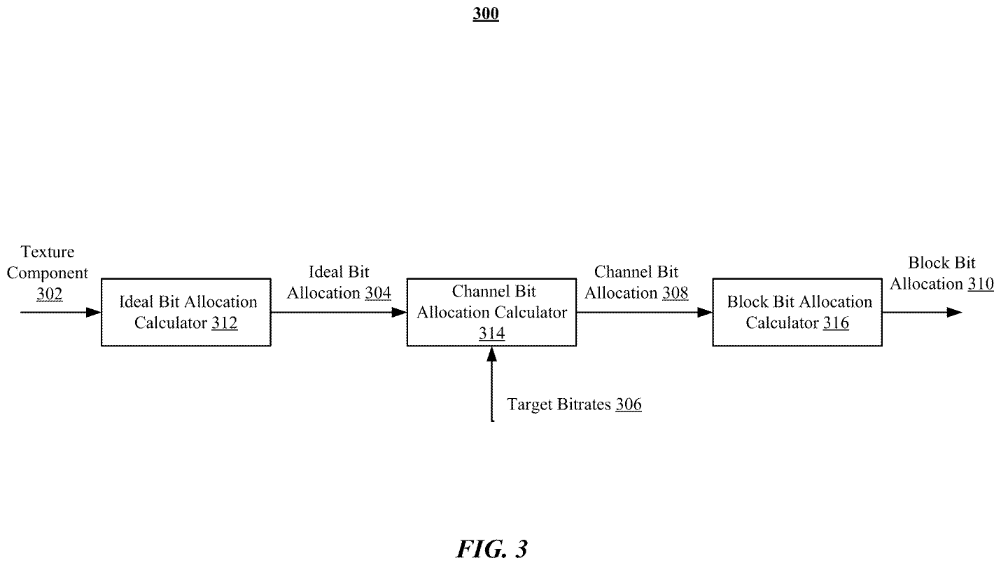

Indeed, as will be further appreciated with respect to FIGS. 3-8, and 9A-9B, the codec system 200, and particularly the encoder device 204, may be utilized for (1) receiving target texture components of a pixel region of a target PBR texture set and a target bitrate for encoding the target texture components of the pixel region in the target PBR texture set; (2) determining, using a machine-learning model, a target bit allocation for encoding each of the target texture components of the pixel region based on the target bitrate; and (3) encoding each of the texture components of the pixel region using the target bit allocation for a render to render images based on the compressed texture components with best qualities, among various other techniques in accordance with the presently disclosed embodiments.

FIG. 3 illustrates an example renderer-aware smart bit allocation system. In some embodiments, a computing system (e.g., a codec system 200) may receive training texture components of a physically-based rendering (PBR) texture set for rendering an N-bit image (e.g., 64 bit image). The texture components of the texture set may comprise one or more of (R)ed, (G)reen, (B)lue color components, a metallic component, a normal component, a roughness component, a displacement component, a specular component, ambient occlusion component, an albedo component, a transparency component, and a fuzz component. Different renderer may treat the texture set with different weights of different texture component. As an example and not by way of limitation, a physically based renderer may adopt the bidirectional reflectance distribution function (BRDF) equations to give different weight to different texture components. The computing system (e.g., codec system 200) may learn to compress the texture component to different degrees in order to achieve the optimal rendering with the least amount of bits. As an example and not by way of limitation, the computing system may receive a texture component 302, which is one of the multiple texture components and then calculate, using an ideal bit allocation calculator 312, an ideal bit allocation 304, for the texture set. The ideal bit allocation 304 for the texture component 302 may comprise a weight (e.g., 8 bits) for the texture component for the renderer to render images based on the texture set 302 for best qualities. The ideal bit allocation 304 may not be restricted by a total amount of bit for compressing the texture set. The computing system may receive a target bitrate 306 (e.g., 16 bits per pixel) and further calculate channel bit allocation 308 of the texture component 302 based on the target bitrate 306 and ideal bit allocation 304. As an example and not by way of limitation, due to the target bitrate as a budget for compression of the texture set, the channel bit allocation 308 may be different from the ideal bit allocation 304. The computing system may calculate, using a block bit allocation calculator 316, a block bit allocation 310 on a pixel region by pixel region basis. The block bit allocation for the texture component 302 may vary depending on image properties for each pixel region.

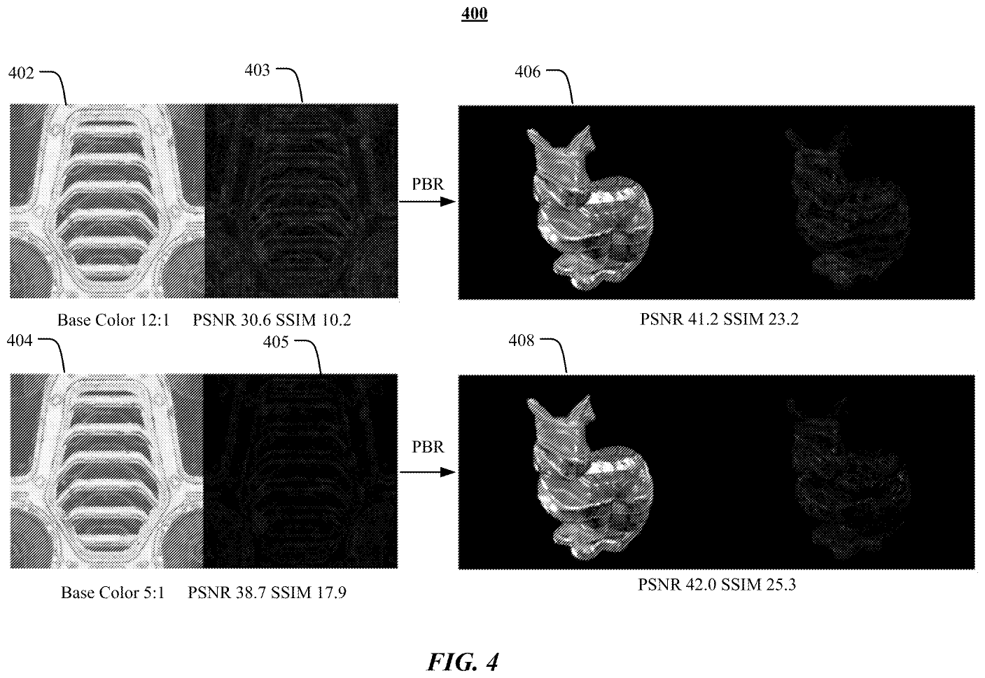

FIG. 4 illustrates a comparison of images rendered by physically based renderer of different base color compression ratios for metal material. In some embodiments, the encoder 204 of the codec system 200 may be aware of how the texture components of the texture set is being used in the physically based renderer to make the optimal decision of compressing the image. As an example and not by way of limitation, the base color image 402 of a metal material is compressed at a compression ratio of 12:1 with a measurement of image quality peak signal-to-noise ratio (PSNR) value of 30.6 dB and structural similarity index measure (SSIM) of 10.2 dB. The base color image 404 of the same metal material is compressed at a compression ratio of 5:1 with a PSNR value of 38.7 dB and an SSIM value of 17.9 dB. The base color image 404 has higher quality and fewer error signals in error heatmap 405 compared to error heatmap 403. The base color map 402 and 404 may be fed to a physically based renderer, the rendered image 406 that is render based on the lower quality base color map 402 has a PSNR value of 41.2 dB and SSIM value of 23.2; the rendered image 408 that is render based on the higher quality base color map 402 has a PSNR value of 42.0 dB and SSIM value of 25.3. The rendered image 406 and 408 has similar qualities even if the base color image 402 and 404 are compressed at drastically different compression ratios. For metal material, base color components may be compressed more, which may save the total amount of bit for other components that influence the rendered image quality. In some embodiments, base color components may cost more bits for compression because the base color components may have more influence on the quality of the rendered image.

In some embodiments, a computer system (e.g., a codec system 200) may receive an arbitrary PBR texture set and a target bitrate (e.g., 15 bits per pixel). The arbitrary PBR texture set may comprise one or more of a base color (RGB) map, a diffusion map, a metallic map, a roughness map, a normal map, or the like. The computing system may determine a bit allocation for each texture component of the texture set to achieve the best-rendered quality. The computing system may use a machine learning model to determine the bit allocation for each texture component of the texture set. As an example and not by way of limitation, the computing system may receive the target bitrate of 15 bits per pixel and a PBR texture set that comprises a base color map, a metallic map, a roughness map, and a normal map. The computing system may use the machine learning model to determine a bit allocation for compressing the base color map, the metallic map, the roughness map and the normal map to 6 bits per pixel, 4 bits per pixel, 3 bits per pixel, and 2 bits per pixel, respectively. The computing system may then compress the base color map, the metallic map, the roughness map and the normal map according to the bit allocation. The physically based renderer may render images based on the compressed texture components. the rendered images associated with the determined bit allocation may have better image qualities comparing to using other possible combinations of the bit allocation for the base color map, the metallic map, the roughness map and the normal map. Additionally or alternatively, the computing system may determine the bit allocation on a pixel region by pixel region basis (e.g., 8*8 pixel block). In some embodiments, the computing system may determine each bit allocation [x, y, z, q] (e.g., x—corresponding to the base color map; y—corresponding to the all of the metallic map; z—corresponding to the roughness map; and q—corresponding to the normal map) for a pixel block according to image features associated with the particular pixel block. As an example and not by way of limitation, the computing system may determine a first bit allocation [6, 4, 3, 2] for a first pixel region and a second bit allocation [2, 6, 5, 2] for a second pixel region. The second region may be associated with a metal material since the bit allocated for the metallic map weights more than bits allocated for other maps.

In some embodiments, the computing system may train the machine learning model according to a plurality of training PBR texture sets. The machine learning model may receive the plurality of training PBR texture sets, and desired training bit allocation associated with each training PBR texture set. As an example and not by way of limitation, one particular training PBR texture set that includes a base color component, a metallic component, a roughness component, and a normal component, the total training bitrate of 15 bits per pixel, and the desired bit allocation of [6, 4, 3, 2] may consist of one data set of the training data fed to the machine learning model. The machine learning model may receive the particular training PBR texture set with another total training bitrate, and another desired bit allocation associated with the other total training bitrate. In order to determine the training data set, particularly the desired bit allocation, the computing system may perform a rendering quality evaluation for each of the training PBR texture sets.

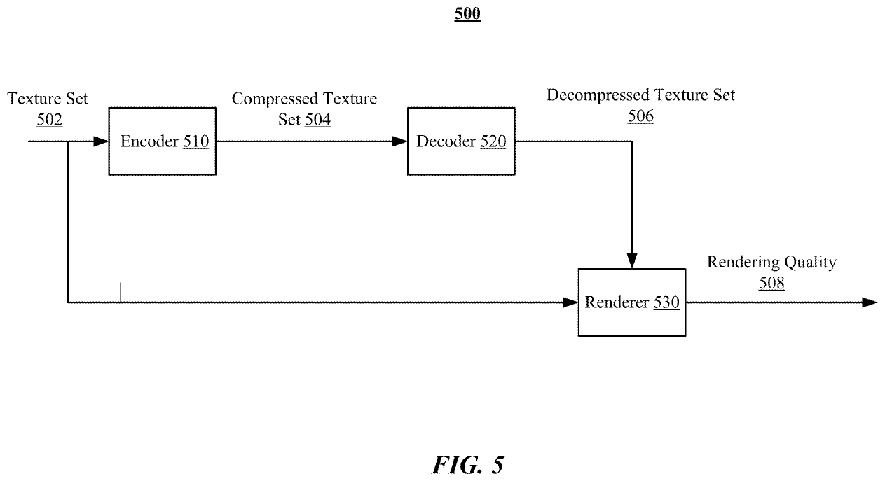

FIG. 5 illustrates an example of a rendering quality evaluation pipeline. The encoder 510 may receive a texture set 502 of a material for physically based rendering. The encoder 510 may compress texture set 502 and sent the compressed texture set 504 to the decoder 502. The decoder 520 may decompress the compressed texture set 504 and then may send the decompressed texture set 506 to a renderer 530 (e.g., PBR renderer). The renderer 530 may also receive the original texture set 502. The computing system may determine a rendering quality 508 based on comparing the image rendered based on the decompressed texture set 506 and the image rendered based on the original textures set 502. The computing system may determine a rendering quality based on PSNR values of the rendered images. In some embodiments, the encoder 510 may encode the texture set 502 in different ways. As an example and not by way of limitation, the encoder 510 may use different bit allocations for the texture components of the texture set 502. The encoder 510 may send different compressed texture set associated with the different bit allocations to the subsequent processing unit (e.g., decoder 520 and renderer 530). The computing system may determine the desired bit allocation based on the rendering quality 508.

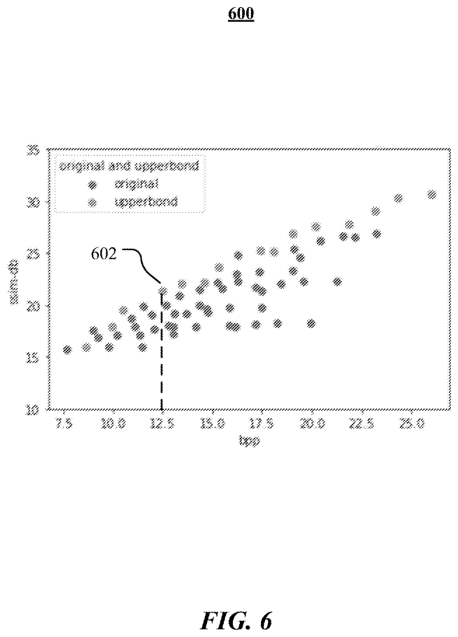

FIG. 6 illustrates an example plot for determining a desired bit allocation for each of the plurality of total training bitrates for encoding the training components of a training texture set. In some embodiment, the computing system may receive a training PBR texture set that comprises training texture components. The training PBR texture set may be associated with a material (e.g., metal). The training PBR texture set may be an N-bit texture set. As an example and not by way of limitation, the training texture components may include base color components, metallic components, roughness components, and normal components. The encoder 204 may encode each training texture components at different bitrates [x, y, z, q] (e.g., x—corresponding to the base color map; y—corresponding to the metallic map; z—corresponding to the roughness map; and q—corresponding to the normal map). As an example and not by way of limitation, the base color map may be encoded at x₁=1, x₂=3, x₃=6, x₄=10, etc. The encoder 204 may enumerate all possible combinations (e.g., xᵢ+yᵢ+zᵢ+qᵢ≤N) of the training texture components for the renderer of the rendering quality evaluation pipeline as shown in FIG. 5 to create a different rendering for the material. The scatter plot in FIG. 6 shows the relationship between the target bitrate (x-axis) and the rendering quality (y-axis) for all possible rendering that each corresponds to the possible combinations of the training texture components. Individual data points that form the upper bond are associated with the best rendering image qualities. As an example and not by way of limitation, at data point 602, the target bitrate is 12.5 bits per pixel (bpp) and the best rendering quality may reach an SSIM value of 22 dB. The encoder may extract the combination of bitrates to compress each texture component, leading to the best rendering quality. The computing system may determine the desired bit allocations associated with the target bitrate according to the upper bond data points as plotted in FIG. 6.

In some embodiments, the computing system may receive training texture components of an N-bit training physically-based rendering (PBR) texture set (e.g., 64-bit PBR texture set). As an example and not by way of limitation, the training texture components may comprise one or more of (R)ed, (G)reen, (B)lue color components, a metallic component, a normal component, a roughness component, a displacement component, a specular component, ambient occlusion component, an albedo component, a transparency component, and a fuzz component. The training PBR texture set may be associated with a particular material. The computing device may receive a plurality of PBR training sets are associated a plurality of materials.

In some embodiments, the computing system may encode each training texture component at a plurality of training bitrates. As an example and not by way of limitation, the computing system may encode the metallic component at each bits per pixel from 0 bits/pixel to 24 bits/pixel, and may obtain 25 different compressed metallic component. The computing system may then render a plurality of reconstructed images associated with a plurality of total training bitrates for encoding the training components based on combinations of decoded training texture components at the plurality of training bitrates. As an example and not by way of limitation, the computing system may render the reconstructed images based on all possible combinations of the encoded training texture components.

In some embodiments, the computing system may determine image qualities of the plurality of reconstructed images based on comparisons to the images that are rendered based on the training PBR texture set in similar ways as described in FIG. 6. The computing system may continue to determine a desired reconstructed image for each of the plurality of total training bitrates for encoding the training components. The desired reconstructed image may have the best image quality (e.g., highest PSNR or highest SSIM). As an example and not by way of limitation, the total training bitrates for encoding the training components of a 64-bit PBR texture set may have a range of 8 bits/pixel to 32 bits/pixel, which indicates a compression ratio is between ⅛ to ½. The computing system may determine the desired reconstructed image at each total training bitrates (e.g., from 8 bits/pixel to 32 bits/pixel). The computing system may then extract a desired training bit allocation across the training texture components associated with the desired reconstructed image for each of the plurality of total training bitrates for encoding the training texture components. As an example and not by way of limitation, the computing system may receive the training PBR texture set with 4 different training texture components, the desired training bit allocation may be [b1, b2, b3, b4] (e.g., b1—corresponding to the all of the first of the training texture components; b2—corresponding to the all of the second of the training texture components; b3—corresponding to the all of the third of the training texture components; and b4—corresponding to the all of the fourth of the training texture components) across the training texture components associated, wherein the summation of b1, b2, b3, and b4 equals to the total training bitrates (e.g., 8 bits/pixel). In some embodiments, the summation of b1, b2, b3, and b4 may be less than the training bitrates.

In some embodiments, the computing system may divide each of texture map corresponding to the texture component of the PBR texture set into pixel regions. As an example and not by way of limitation, the pixel regions may be a plurality of 8*8 pixel regions since different image pixel regions may contain different information associated with different materials. The computing system may determine a plurality of desired bit allocations across the training components for the divided pixel regions of the training PBR texture set. Such division may enrich the training dataset.

The computing system may then train a machine-learning model to learn a bit allocation for encoding each texture component using the training texture components, the plurality of total training bitrates for encoding the training components, and the desired training bit allocation across the training texture components. In some embodiments, the machine learning model may be implemented based on a neural network, random forest, gradient boosting, and the like. In some embodiment, the computing system may determine one or more texture features for each training texture component. As an example and not by way of limitation, the computing system may determine one or more texture features associated with a particular material since different materials may have different optimal bit allocations for the same target bitrate. The computing device may feed the texture features to the machine learning model together with the training components, the plurality of total training bitrates for encoding the training components, and the desired training bit allocation across the training texture components.

In some embodiments, the computing system may access target texture components of a pixel region of a target PBR texture set. The target PBR texture set may be an arbitrary texture set. The computing system may receive a target bitrate for encoding the target texture components of the pixel region in the target PBR texture set. The computing system may then determine, using the trained machine-learning model a target bit allocation for encoding each of the target texture components of the pixel region based on the target bitrate. As an example and not by way of limitation, the computing system may access a target base color (RGB) component, a target metallic component, and a target roughness component of an n×n pixel region (e.g., n=16) and may receive a target bitrate M (e.g., M=15) as a budget for comprising the target base color component, the target metallic component, and the target roughness component of the n×n pixel region. The computing system may feed the trained machine learning model with the target base color component, the target metallic component, and the target roughness component of the n×n pixel region, and the target bitrate M=15. The machine learning model within the computing system may determine for this n×n pixel region, a target bit allocation [x, y, z] (e.g., x—corresponding to the base color component; y—corresponding to the metallic component; and z—corresponding to the roughness component). The computing system may continue to access next n×n pixel region within the target PBR texture set and determine bit allocation for the next n×n pixel region. In some embodiments, different pixel regions of the rendered image may have the same bit allocations. In some embodiments, different pixel regions of the rendered image may have different bit allocations. As an example not by way of limitation, the pixel regions that are adjacent to each other may be compressed based on the same bit allocations for each texture component since the two adjacent pixel regions may be located within the area for the same material (e.g., area for a metal). As an example not by way of limitation, the pixel regions that are far away from each other may be compressed based on different bit allocations for each texture component since the two distant pixel regions may be located in different regions of different materials (e.g., one pixel region corresponds to a base color background area, another pixel region corresponds to a metal object area).

In some embodiments, the computing system may divide each texture map corresponding to the texture component of the PBR texture set into pixel regions of variable sizes. As an example not by way of limitation, the computing system may divide the texture map into a plurality of n×n (n=8) pixel regions, a plurality of p×p (p=16) pixel regions, and q×q (q=32) pixel regions. The computing system may determine identical bit allocations for the pixel regions of variable sizes. Additionally or alternatively, the computing system may determine different bit allocations for the pixel regions of variable sizes.

In some embodiments, the computing device may exhaust the budget of the target bitrate when determining the target bit allocation for encoding each of the target texture components of each pixel region based on the target bitrate. Additionally or alternatively, the computing device may save a portion of the budget of the target bitrate when determining the target bit allocation since the image that is rendered based on textures compressed with fewer bits may have similar image qualities than those rendered based on textures compressed with budget bits. In some embodiments, an average bit usage for compressing each pixel region may stay within the budget of the target bitrate. That is, the computer system may determine a first bit allocation with a first total bit usage less than the budget bits for a first pixel region, while the computer system may determine a second bit allocation with a second total bit usage greater than the budget bits for a second pixel region as long as the average bit usage of the first and second pixel region does not exceed the budget of the target allocation bitrate. As an example not by way of limitation, the computing system may determine, for a PBR texture set that comprises four texture components, the first bit allocation [3, 2, 1, 2] (total bits=8) for the first pixel region, and the second bit allocation [8, 6, 5, 3] (total bits=22) for the second pixel region. The average bit usage ((8+22)/2=15) of the first pixel region and the second pixel region may stay within the budget of the target bitrate (e.g., target bitrate=15 bpp, 15≤15). In some embodiments, the computing system may determine the bit allocation for the texture components of the first region, save the bit allocation for the texture components of the first region, and may adopt the saved bit allocation to compress the texture components of the second region.

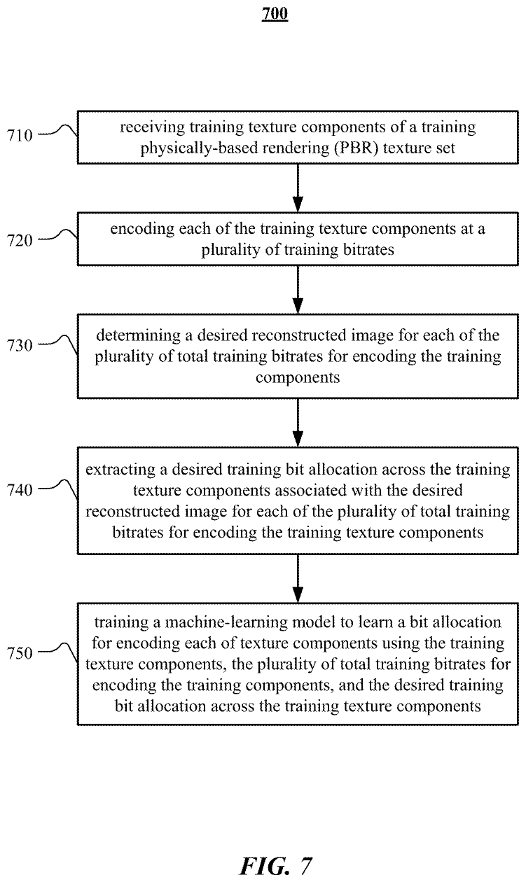

FIG. 7 illustrates a flow diagram of a method for training a machine-learning model to learn a smart bit allocation across channels for encoding each texture component of a physically based rendering texture set. FIG. 7 illustrates an example method 700 for training a machine-learning model to learn a smart bit allocation across channels for encoding each texture component of a physically based rendering texture set. The method may begin at step 710, where the computing system may receive training texture components of a training physically-based rendering (PBR) texture set. At step 720, the computing system may encode each of the training texture components at a plurality of training bitrates. At step 730, the computing system may determine a desired reconstructed image for each of the plurality of total training bitrates for encoding the training components. At step 740, the computing system may extract a desired training bit allocation across the training texture components associated with the desired reconstructed image for each of the plurality of total training bitrates for encoding the training texture components. At step 750, the computing system may train a machine-learning model to learn a bit allocation for encoding each of texture components using the training texture components, the plurality of total training bitrates for encoding the training components, and the desired training bit allocation across the training texture components. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for training a machine-learning model to learn a smart bit allocation across channels for encoding each texture component of a physically based rendering texture set including the particular steps of the method of FIG. 7, this disclosure contemplates any suitable method for training a machine-learning model to learn a smart bit allocation across channels for encoding each texture component of a physically based rendering texture set including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

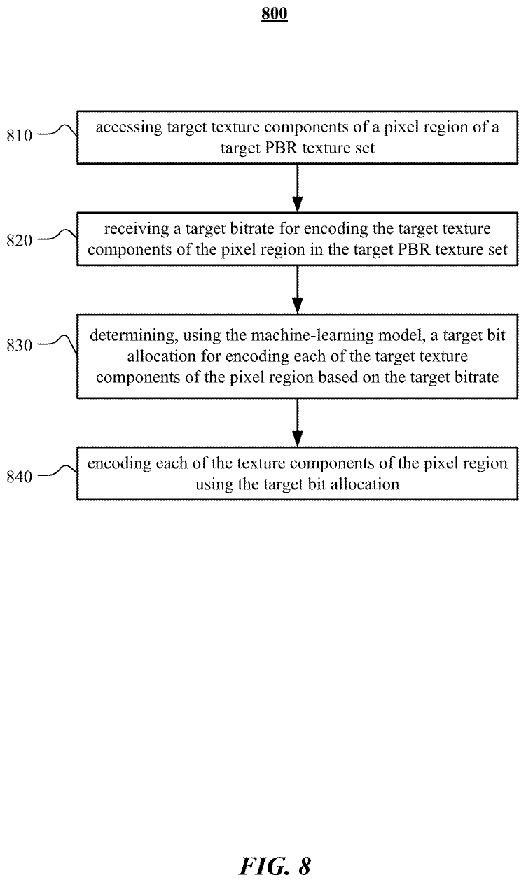

FIG. 8 illustrates a flow diagram of a method for determining a smart bit allocation across channels for textures components compression. FIG. 8 illustrates an example method 800 for determining a smart bit allocation across channels for textures components compression. The method may begin at step 810, where the computing system may access target texture components of a pixel region of a target PBR texture set. At step 820, the computing system may receive a target bitrate for encoding the target texture components of the pixel region in the target PBR texture set. At step 830, the computing system may determine, using the machine-learning model, a target bit allocation for encoding each of the target texture components of the pixel region based on the target bitrate. At step 840, the computing system may encode each of the texture components of the pixel region using the target bit allocation. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for determining a smart bit allocation across channels for textures components compression including the particular steps of the method of FIG. 8, this disclosure contemplates any suitable method for determining a smart bit allocation across channels for textures components compression including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

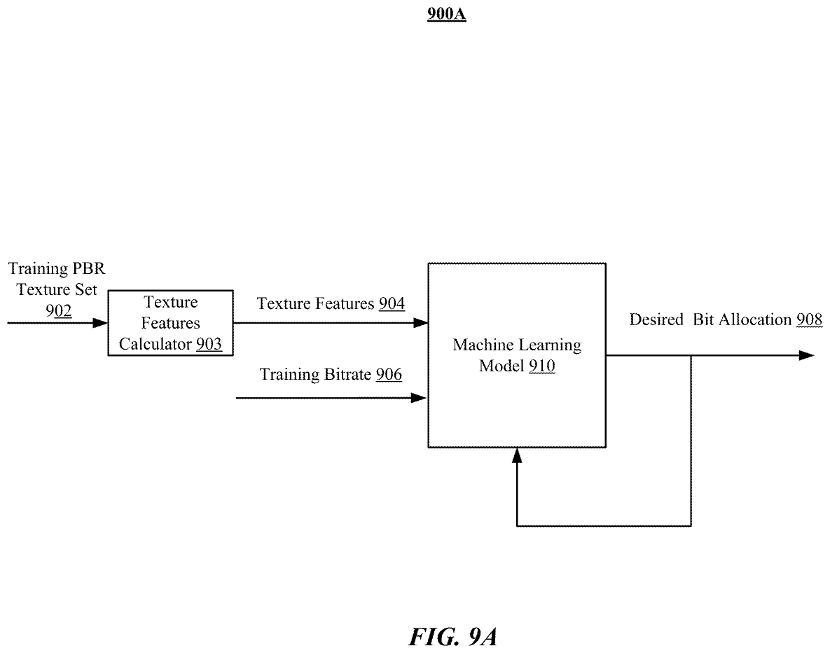

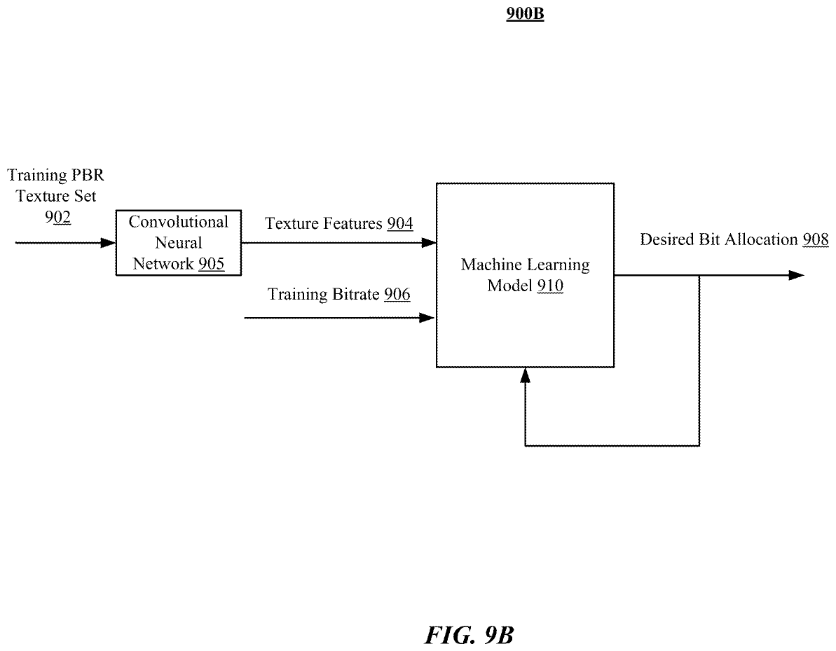

FIG. 9A illustrates an example of pre-analysis of the texture components with extracting texture features. In some embodiments, determine one or more texture features for each of the training texture components. As an example and not by way of limitation, the computing system may determine one or more texture features associated with a particular material since different materials may have different optimal bit allocation for the same target bitrate. In some embodiment, the computing system may perform a pre-analysis of the training texture components of the training PBR texture set 902 (e.g., on a pixel region by pixel region basis) to determine, using a texture feature calculator 903, the one or more texture features 904 associated with a particular material before feeding the training texture components to the machine learning model. The pre-analysis may comprise determining a mean (e.g., an average of the total pixel value) and a variance (e.g., a measure of the average degree to which each training texture component is different from the mean value) with respect to each of the training texture components of each pixel per pixel region. The computing system may feed the one or more texture features 904 to the machine learning model together with the training PBR texture set 902, the plurality of total training bitrates 906 for encoding the training components, and the desired training bit allocation 908 across the training texture components of the training PBR texture set 902. At time when the trained machine learning may be used to determine bit allocations for a new target texture set, the computing system may extract textures features (e.g., mean and variance) and provide the trained machine learning model with the texture features, the new target texture set and the target bitrate so that the trained machine learning model may determine, for the new target texture set, a target bit allocation for best rendering image quality.

FIG. 9B illustrates an example of pre-analysis of the texture components with a conventional neural network. In some embodiments, the computing system may perform a pre-analysis of the training texture components of the training PBR texture set 902 (e.g., on a pixel region by pixel region basis) to determine, using a convolutional neural network 905, the one or more texture features 904 associated with a particular material before feeding the training texture components to the machine learning model.

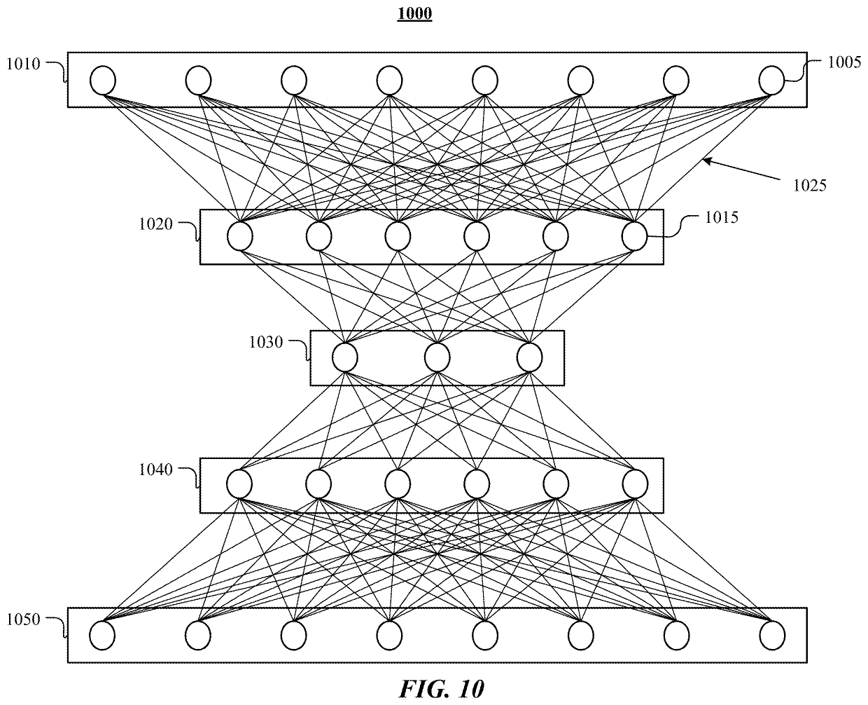

FIG. 10 illustrates an example artificial neural network (“ANN”) 1000. In particular embodiments, an ANN may refer to a computational model comprising one or more nodes. Example ANN 1000 may comprise an input layer 1010, hidden layers 1020, 1030, 1040, and an output layer 1050. Each layer of the ANN 1000 may comprise one or more nodes, such as a node 1005 or a node 1015. In particular embodiments, each node of an ANN may be connected to another node of the ANN. As an example and not by way of limitation, each node of the input layer 1010 may be connected to one of more nodes of the hidden layer 1020. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 10 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 10 depicts a connection between each node of the input layer 1010 and each node of the hidden layer 1020, one or more nodes of the input layer 1010 may not be connected to one or more nodes of the hidden layer 1020.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 1020 may comprise the output of one or more nodes of the input layer 1010. As another example and not by way of limitation, the input to each node of the output layer 1050 may comprise the output of one or more nodes of the hidden layer 1040. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(sₖ)=max(0,sₖ), or any other suitable function Fₓ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 1025 between the node 1005 and the node 1015 may have a weighting coefficient of 0.4, which may indicate that 0.4 multiplied by the output of the node 1005 is used as an input to the node 1015. As another example and not by way of limitation, the output yₖ of node k may be yₖ=Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 1000 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

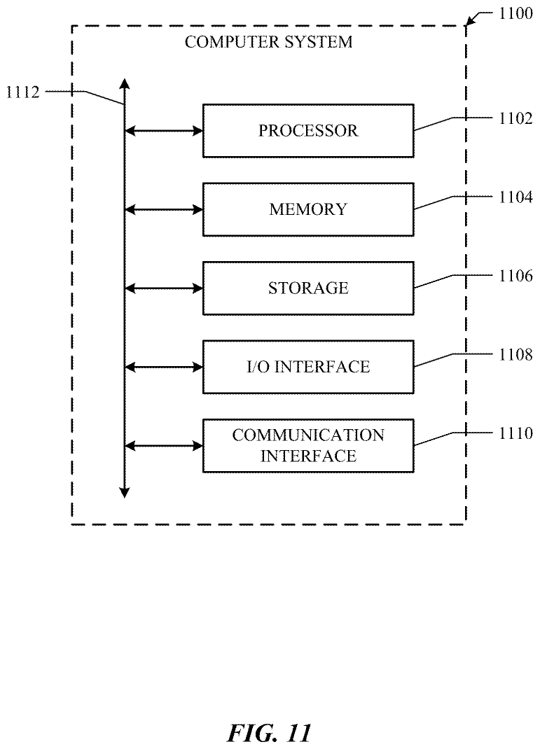

FIG. 11 illustrates an example computer system 1100 that may be useful in performing one or more of the foregoing techniques as presently disclosed herein. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, As an example and not by way of limitation, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein.

As an example, and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate. In certain embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In certain embodiments, processor 1102 includes hardware for executing instructions, such as those making up a computer program. As an example, and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example, and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102.

Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 602. Although this disclosure describes and illustrates a particular processor, this disclosure contemplates any suitable processor.

In certain embodiments, memory 1104 includes main memory for storing instructions for processor 1102 to execute or data for processor 1102 to operate on. As an example, and not by way of limitation, computer system 1100 may load instructions from storage 1106 or another source (such as, As an example and not by way of limitation, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere).

One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example, and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In certain embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In certain embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In certain embodiments, communication interface 1110 includes hardware, software, or both providing one or more interfaces for communication (such as, As an example and not by way of limitation, packet-based communication) between computer system 1100 and one or more other computer systems 1100 or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it.

As an example, and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, As an example and not by way of limitation, a BLUETOOTH WPAN), a WI-FI network, a WI-MAX network, a cellular telephone network (such as, As an example and not by way of limitation, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In certain embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as As an example and not by way of limitation, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method implemented by a computing system, the method comprising:
receiving training texture components of a training physically-based rendering (PBR) texture set;
encoding each of the training texture components at a plurality of training bitrates;
rendering a plurality of reconstructed images associated with a plurality of total training bitrates for encoding the training components based on combinations of decoded training texture components at the plurality of training bitrates;
determining a desired reconstructed image for each of the plurality of total training bitrates for encoding the training components;
extracting a desired training bit allocation across the training texture components associated with the desired reconstructed image for each of the plurality of total training bitrates for encoding the training texture components; and
training a machine-learning model to learn a bit allocation for encoding each of texture components using the training texture components, the plurality of total training bitrates for encoding the training components, and the desired training bit allocation across the training texture components.

2. The method of claim 1, further comprising:
accessing target texture components of a pixel region of a target PBR texture set;
receiving a target bitrate for encoding the target texture components of the pixel region in the target PBR texture set;
determining, using the machine-learning model, a target bit allocation for encoding each of the target texture components of the pixel region based on the target bitrate; and
encoding each of the texture components of the pixel region using the target bit allocation.

3. The method of claim 1, wherein determining the desired reconstructed image for each of the plurality of total training bitrates for encoding the training components further comprising:
determining image qualities of the plurality of reconstructed images based on comparisons to the training PBR texture set; and
determining the desired reconstructed image for each of the plurality of total training bitrates for encoding the training components based on the image qualities.

4. The method of claim 1, further comprising:
determining one or more texture features for each of the training texture components; and
training the machine-learning model to learn the bit allocation for encoding each of texture components using the one or more texture features for each of the training texture components, the plurality of total training bitrates for encoding the training components, and the desired training bit allocation across the training texture components.

5. The method of claim 4, wherein the one or more texture features comprises an image variance.

6. The method of claim 4, wherein the one or more texture features comprises an image mean.

7. The method of claim 4, further comprising:
extracting, using a neural network, the one or more texture features indicating a material for each of the training texture components.

8. A system comprising:
one or more non-transitory computer-readable storage media including instructions; and
one or more processors coupled to the storage media, the one or more processors configured to execute the instructions to:
receive training texture components of a training physically-based rendering (PBR) texture set;
encode each of the training texture components at a plurality of training bitrates;
render a plurality of reconstructed images associated with a plurality of total training bitrates for encoding the training components based on combinations of decoded training texture components at the plurality of training bitrates;
determine a desired reconstructed image for each of the plurality of total training bitrates for encoding the training components;
extract a desired training bit allocation across the training texture components associated with the desired reconstructed image for each of the plurality of total training bitrates for encoding the training texture components; and
train a machine-learning model to learn a bit allocation for encoding each of texture components using the training texture components, the plurality of total training bitrates for encoding the training components, and the desired training bit allocation across the training texture components.

9. The system of claim 8, wherein one or more processors are further configured to execute the instructions to:
access target texture components of a pixel region in a target PBR texture set;
receive a target bitrate for encoding the target texture components of the pixel region in the target PBR texture set;
determine, using the machine-learning model, a target bit allocation for encoding each of the target texture components of the pixel region based on the target bitrate; and
encode each of the texture components of the pixel region using the target bit allocation.

10. The system of claim 8, wherein one or more processors are further configured to execute the instructions to:
determine image qualities of the plurality of reconstructed images based on comparisons to the training PBR texture set; and
determine the desired reconstructed image for each of the plurality of total training bitrates for encoding the training components based on the image qualities.

11. The system of claim 8, wherein one or more processors are further configured to execute the instructions to:
determine one or more texture features for each of the training texture components; and
train the machine-learning model to learn the bit allocation for encoding each of texture components using the one or more texture features for each of the training texture components, the plurality of total training bitrates for encoding the training components, and the desired training bit allocation across the training texture components.

12. The system of claim 11, wherein the one or more texture features comprises an image variance.

13. The system of claim 11, wherein the one or more texture features comprises an image mean.

14. The system of claim 11, wherein one or more processors are further configured to execute the instructions to:
extract, using a neural network, the one or more texture features indicating a material for each of the training texture components.

15. A non-transitory computer-readable medium comprising instructions that, when executed by one or more processors of a computing system, cause the one or more processors to:
receive training texture components of a training physically-based rendering (PBR) texture set;
encode each of the training texture components at a plurality of training bitrates;
render a plurality of reconstructed images associated with a plurality of total training bitrates for encoding the training components based on combinations of decoded training texture components at the plurality of training bitrates;
determine a desired reconstructed image for each of the plurality of total training bitrates for encoding the training components;
extract a desired training bit allocation across the training texture components associated with the desired reconstructed image for each of the plurality of total training bitrates for encoding the training texture components; and
train a machine-learning model to learn a bit allocation for encoding each of texture components using the training texture components, the plurality of total training bitrates for encoding the training components, and the desired training bit allocation across the training texture components.

16. The non-transitory computer-readable medium of claim 15, wherein the instructions further cause the one or more processors to:
access target texture components of a pixel region in a target PBR texture set;
receive a target bitrate for encoding the target texture components of the pixel region in the target PBR texture set;
determine, using the machine-learning model, a target bit allocation for encoding each of the target texture components of the pixel region based on the target bitrate; and
encode each of the texture components of the pixel region using the target bit allocation.

17. The non-transitory computer-readable medium of claim 15, wherein the instructions further cause the one or more processors to:
determine image qualities of the plurality of reconstructed images based on comparisons to the training PBR texture set; and
determine the desired reconstructed image for each of the plurality of total training bitrates for encoding the training components based on the image qualities.

18. The non-transitory computer-readable medium of claim 15, wherein the instructions further cause the one or more processors to:
determine one or more texture features for each of the training texture components; and
train the machine-learning model to learn the bit allocation for encoding each of texture components using the one or more texture features for each of the training texture components, the plurality of total training bitrates for encoding the training components, and the desired training bit allocation across the training texture components.

19. The non-transitory computer-readable medium of claim 18, wherein the one or more texture features comprises an image variance.

20. The non-transitory computer-readable medium of claim 18, wherein the one or more texture features comprises an image mean.
